(19) United States
(12) Patent Application Publication
(10) Pub. No.: US 2007/0250616 A1
(43) Pub. Date: Oct. 25, 2007

(54) Computer networking techniques

(76) Inventors: John Morelli, San Jose, CA (US); Adam Powers, Dublin, CA (US); Delmer Fisher, Indianapolis, IN (US)

Correspondence Address: KRIEG DEVAULT LLP, ONE INDIANA SQUARE, SUITE 2800, INDIANAPOLIS, IN, 46204-2079, US

(21) Appl. No.: 11/701,246

(22) Filed: Feb. 1, 2007

Related U.S. Application Data
(63) Continuation of application No. PCT/US05/27345, filed on Aug. 2, 2005.
(60) Provisional application No. 60/598,374, filed on Aug. 2, 2004.
(60) Provisional application No. 60/688,135, filed on Jun. 6, 2005.

(51) Int. Cl. G06F 15/173

(52) U.S. Cl. 709/223

(57) ABSTRACT

One embodiment includes a dwelling (24), coaxial cabling (25), and a number of networking devices (98) coupled together with cabling (25) to provide a computer network (51). Devices (98) include a master module (100a) and adapters (100) that communicate over network (51) in accordance with a first communication protocol. Module (100a) generates: a first signal to invite adapter communication over network (51); a second signal to prompt communication by one of adapters (100) if it is the only one that responded to the first signal; and a third signal if two or more of adapters (100) responded to the first signal. The one of adapters (100) responds to the second signal by broadcasting information over network (51) and the two or more adapters (100) respond to the third signal by randomly delaying further transmission.

### CROSS-REFERENCE TO RELATED APPLICATIONS

The present application is a continuation of International Patent Application No. PCT/US2005/027345 filed 2 Aug. 2005, which claims the benefit of U.S. Provisional Patent Application No. 60/598,374 filed Aug. 2, 2004 and U.S. Provisional Patent Application No. 60/688,135 filed Jun. 6, 2005, all of which are hereby incorporated by reference each in its entirety.

### BACKGROUND

The present invention relates to networking, and more particularly, but not exclusively, relates to the implementation of a network with wiring previously installed for television programming transmission.

Interest has increasingly grown in the provision of broadband computer network communication services to personal residences. There is also a growing desire to provide a network for communication between devices within one's personal residence. In one application often of interest, this network arrangement is suitable to transmit multiple digital video streams and/or other digitized entertainment media to various devices within a residence. Prior attempts to meet such needs suffer from poor reliability; complicated software, firmware, or hardware installation procedures; and/or high latency. Thus, there is a demand for further contributions in this area of technology.

### SUMMARY

One embodiment of the present application is a unique networking technique. Other embodiments include unique methods, systems, devices, and apparatus for networking. Such embodiments permit transmission of computer data and/or other forms of communication such as voice, video, or audio to name just a few. Still further embodiments, objects, features, aspects, benefits, advantages, and forms of the present invention shall become apparent from the detailed description and drawings provided herewith.

### BRIEF DESCRIPTION OF THE DRAWING

FIG. 1 is a schematic view of a network system.

FIGS. 2 and 3 are schematic views depicting a representative networking device of the network shown in FIG. 1 in greater detail.

FIG. 4 is timing diagram illustrating one mode of arbitrating communication for the system of FIG. 1.

FIGS. 5 and 6 are schematic views depicting circuitry implementing a representative networking device.

### DETAILED DESCRIPTION OF SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

Among the embodiments of the present application is an intrabuilding network system having a number of networking devices connected by coaxial cabling. One of these devices is designated as a communication master that controls communications over the network over a single, time-shared channel. These communications are direct from one device to the next without up-conversion, down-conversion or remodulation therebetween. This system permits the transmission of computer data from one device to another within the building at low cost and with relative ease of installment, and facilitates the transmission of digital information, such as digitized voice, video, audio, and the like.

In one form, the adapters each include an ethernet interface. Correspondingly, equipment coupled to the ethernet interface of one networking device in one room of the building can communicate with other equipment coupled to the ethernet interface of another networking device in a different room of the building. The networking system can be added to buildings by coupling the adapters together with coaxial cabling previously installed for the transmission of television programming. This form is particularly appealing for residential dwellings in which an internal networking capability is desired. Nonetheless, in other embodiments coaxial cabling may be completely or partially replaced by another communication medium or media such as a different type of electrical wiring, optical transmission lines, and/or wireless transmission links. Alternatively or additionally, a building type other than a residential dwelling may be networked in accordance with the present invention and/or the present invention may be applied in situations where the networking medium/media, is installed after or at the same time as one or more of the networking devices.

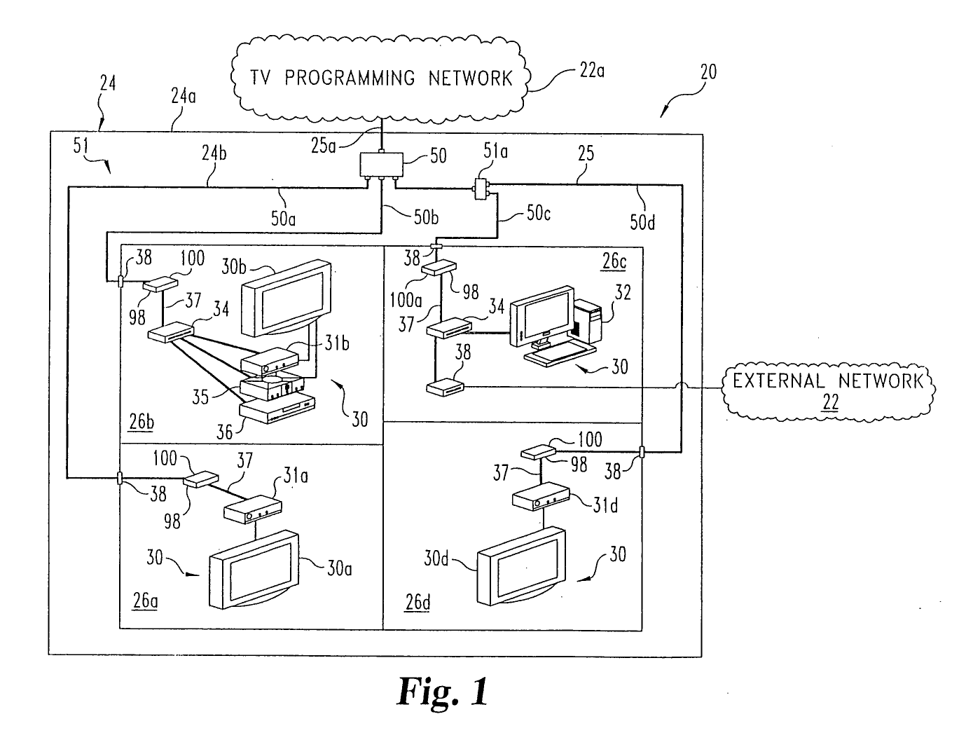

FIG. 1 diagrammatically depicts networking system 20 of a further embodiment of the present invention. In system 20, external network 22 is coupled to building 24. External network 22 includes a broadband computer network, and may be of the type that provides a Wide Area Network (WAN) such as the internet, and/or Municipal Area Network (MAN). Building 24 is depicted in the form of residential dwelling 24a, which can be a single family home, duplex, apartment, or the like; however, in other embodiments, building 24 can be an office, another commercial or industrial type of dwelling, or such different building type as would be desired for application of the present invention.

Internal to dwelling 24a, is wiring network 24b in the form of coaxial cabling 25. Cabling 25 is the type commonly used to provide cable television programming within a home. Cabling 25 is in communication with television programming network 22a via coaxial drop cable 25a that is at least partially external to dwelling 24a. Cabling 25 is coupled to cable 25a via demarcation point coaxial cable splitter 50. For the depicted example, cabling 25 includes separate cable lines 50a, 50b, 50c, and 50d connecting splitter 50 to coaxial cable connectors 38 in rooms 26a, 26b, 26c, and 26d of dwelling 24a, respectively. It should be understood that cable lines 50c and 50d are coupled to splitter 50 via secondary splitter 51a. At the demarcation point, filtering may be employed to lower port-to-port isolation of the splitters.

Premises equipment, designated local devices 30, are coupled to each connector 38. Devices 30 include televisions (TVs) 30a, 30b, and 30d in respective rooms 26a, 26b, and 26d. Each television is connected to a respective set-top box 31a, 31b, and 31d. Devices 30 also include computer 32 in room 26c. Devices 30 further include Local Area Network (LAN) switches 34 of an Ethernet type, XBOX game system 35, digital video recorder (DVR) 36, and broadband computer modem 38. Modem 38 is connected to external computer network 22.

While not shown to preserve clarity, in other embodiments, devices 30 could include a LAN router or hub, a wireless network communication subsystem, or an audio system just to name a few. Alternatively or additionally, there may be more or fewer devices 30, devices 30 may vary in type and location from that depicted, and/or the number of rooms may be greater or fewer. In one alternative embodiment, computer 32 is a portable, laptop type that is wirelessly linked to a router. For this laptop form, computer 32 can readily be used in various rooms of dwelling 24a, and optionally in nearby outdoor locations, while still maintaining a wireless network communication link. In other embodiments, wireless links may be absent or differently arranged. Each of rooms of 26a, 26b, 26c, and 26d include a network communication endpoint in the form of networking device 98. Networking devices 98 include network communication adapters 100 and master communication device 100a each coupled between a corresponding connector 38 and one or more of devices 30. Networking devices 98 each provide a corresponding port to Ethernet bus 37. In room 26c, master communication device 100a controls communications between all networking devices 98 as will be more fully explained hereinafter. Collectively, networking devices 98 and cabling 25 provide premises network 51 that can also be utilized to distribute information in the form of computer network data, voice communications, audio programming, and/or video streams (including, but not limited to security camera transmissions), only to name a few. Moreover, network 51 can be used to communicate from one of local devices 30 coupled to networking device 98 in one room to another of local devices 30 coupled to networking device 98 in another room. One or more external communication links other than network 22 and network 22a may additionally or alternatively be coupled to premised network 51 (not shown). In other embodiments, more or fewer networking devices 98 can be utilized and/or one or more additional coaxial cable splitters can be connected, or cables therefrom, to provide connections to additional networking devices 98. While three adapters 100 are shown, it should be appreciated that more or fewer adapters 100 could be utilized in other embodiments.

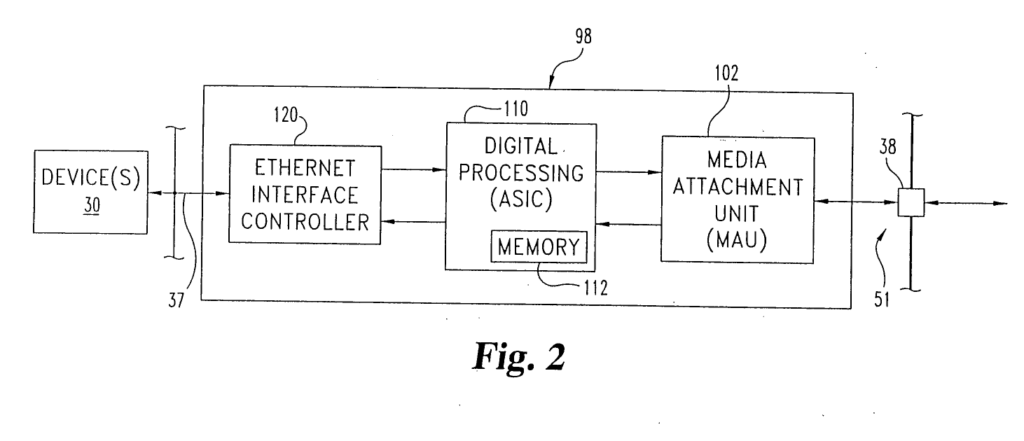

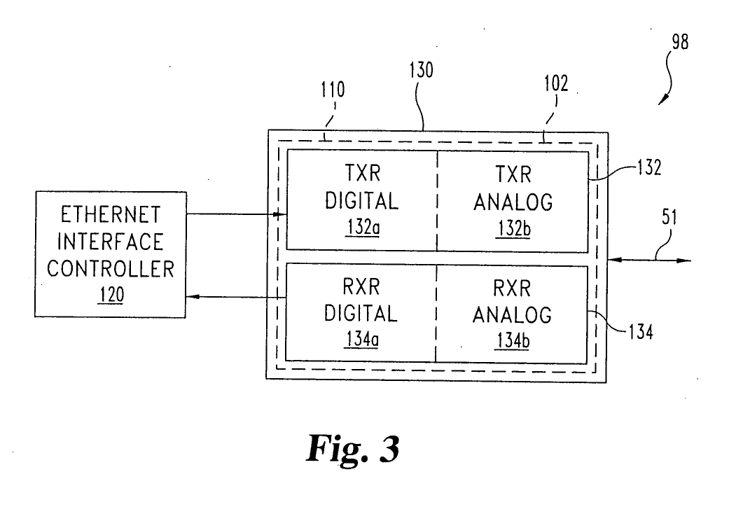

Referring additionally to FIGS. 2 and 3, further details about networking devices 98 are next described. With respect to these descriptions, adapter 100 and master device 100a can be configured the same except for certain operational characteristics of device 100a that differ from adapter 100 as will be more fully described hereinafter. FIG. 2 provides a representative, schematic depiction of networking device 98. Networking device 98 includes an Analog Front End (AFE) interface 102 in the form of Media Attachment Unit (MAU) that provides an interface to network 51 via coaxial connector 38. In one form directed to operation with a center frequency of 80 MHz and 40 MHz of bandwidth, interface 102 is a passive network of resistor, capacitor and/or inductor elements. In other embodiments of the present application directed to preservation of cable television programming or Digital Broadcast Satellite (DBS) television programming, interface 102 includes modulation/demodulation circuitry, filters, limiters, amplifiers, and the like as would occur to one skilled in the art to provide analog aspects of a transceiver 130 (see FIG. 3) operable within network 51.

Interface 102 is also coupled to digital processing circuitry 110 which is illustrated in the form of a Field Programmable Gate Array (FPGA) with memory 112. Processing circuitry 110 can be of a programmable type; a dedicated, hardwired state machine; or a combination of these. Circuitry 110 performs in accordance with operating logic that can be defined by software programming instructions, firmware, dedicated hardware, a combination of these, or in a different manner as would occur to those skilled in the art. The difference between adapter 100 and master device 100a is found in this operating logic and so is not particularly amenable to distinction in the schematic views of FIGS. 2 and 3.

In other embodiments, circuitry 110 can be comprised of one or more types of components as an alternative or addition to an FPGA—collectively being arranged to operate as described herein. At least a portion of memory 112 is of a nonvolatile type suitable to store operating logic for circuitry 110 in the form of instructions; however, in other embodiments such memory may differ or be absent. As appropriate for the particular communication technique utilized, at least one of interface 102 and circuitry 110 can include an analog-to-digital converter (ADC) and/or a digital-to-analog converter (DAC); one or more signal filters; limiters; oscillators; power supplies; and/or other signal operators, sources, generators, and/or conditioners as appropriate to operate in the manner desired.

Networking device 98 further includes an Ethernet interface and corresponding controller 120. In one form, controller 120 provides digital signal interfacing of networking device 98 with bus 37 by defining a 100BASETX Ethernet interface and buffer. More specifically, operating logic for controller 120 defines an Ethernet Media Access Control (MAC layer) that interfaces with Ethernet Physical Layer Control (PHY). This operating logic is further configured for Ethernet-compatible communication with local device(s) 30 coupled to networking device 98 by an Ethernet port. Controller 120 can be comprised of one or more general-purpose or dedicated types of components, be at least partially included in the FPGA for circuitry 110, and/or be at least partially included in a different FPGA and/or other integrated circuit type. Controller 120 can be of a programmable type; a dedicated, hardwired state machine; or a combination of these. Operating logic of controller 120 can be defined by software programming instructions, firmware, dedicated hardware, a combination of these, or in a different manner as would occur to those skilled in the art.

As more specifically illustrated in FIG. 3, networking device 98 is logically depicted as including transceiver 130 with transmitter (TXR) 132 and receiver (RXR) 134. While TXR 132 and RXR 134 are shown separately, the circuitry, components, and/or logic comprising one can at least partially be used to provide the other. TXR 132 is further logically represented as TXR digital portion 132a and TXR analog portion 132b, and RXR 134 is further logically represented as RXR digital portion 134a and RXR analog portion 134b. For the depicted embodiment, digital portions 132a, 134a are defined by circuitry 110, while analog portions are defined by interface 102; however, it should be understood that implementation may differ in other embodiments.

Referring generally to FIGS. 1-3, one mode of installing system 20 is next described. Specifically, system 20 can be implemented by using previously installed coaxial cabling provided for transmission of cable or DBS television programming. One form of this installation includes coupling networking devices 98 together with this previously installed cabling 25 to provide premises network 51. Devices 30 are each interfaced to network 51 through one of networking devices 98. As illustrated in FIG. 1, typically one networking device 98 is used for each room of dwelling 24a. When it is desired to couple more than one of devices 30 to network 51, then Ethernet switch 34 is utilized.

Each networking device 98 operates as a bridge between premises network 51 and a corresponding Ethernet port for bus 37 by selectively sending information signals (data) to the other networking devices 98 and receiving information signals from the other networking devices 98. Because information signals from all other networking devices 98 are received, only some may be selectively utilized by a given receiving networking device 98, with the rest being ignored or discarded. In one embodiment of the present application, network 51 operates by providing for communications between networking devices 98 in a frequency band that overlaps cable or satellite television programming transmission via cabling 25. As a result, for this embodiment cabling 25 can no longer be used to deliver such television programming in an acceptable manner. In one particular implementation of this embodiment, networking devices 98 are each configured to communicate over a single channel on network 51 with a center frequency of about 80 MHz and a bandwidth of about 40 MHz by encoding a Binary Phase Shift Key (BPSK) data signal having a signal level of about 50 dB. This implementation has provided a half-duplex, 40 Mb/second channel, which is unfiltered and spread spectrum; and provides low latency (<1 millisecond), a Bit Error Rate (BER) of no more than 1 part in 10⁹, and allows for up to 6 HDTV streams at 6 MB/s each. This arrangement is often particularly desirable for customer-installed networks. Further, at least a half-duplex 80 Mb/second channel also appears possible with this approach. Nonetheless, in other embodiments, other frequency bands, coding, modulation, and the like may be used. In one alternative, communications between networking devices 98 are up-converted or otherwise provided in a bandwidth that does not interfere with at least one of cable or DBS television programming transmission.

For example, in one particular nonlimiting form, devices 98 are configured to establish network 51 to provide an Ethernet-over-Coax (“no new wires”) high-speed, home networking solution that can coexist with standard satellite or cable television service. Correspondingly, this form allows for the spectral isolation of devices 98 from either the Cable TV or Digital Broadcast Satellite (DBS) frequency spectrum. Because different customers have different requirements, the communication channel for network 51 can be re-located anywhere in the available spectrum during manufacturing by changing the set of analog parts used; however, the overall design stays the same—even permitting the same printed circuit board (PCB) to be used for different communication channel center frequencies.

For one implementation, it has been found that a robust and reliable network can be provided in this manner with no less than 125 Mbps of consistent bandwidth. This implementation defines a single 600 MHz-wide communication channel that is configurable during manufacturing to be centered at either 600 MHz or 1.35 GHz to correspondingly preserve the desired cable TV or DBS spectrum. This channel is shared by multiple devices 98 in a fashion that allows for low latency in periods of minimal traffic and high-throughput when multiple data streams are traversing different adapters in the network. For this implementation, it has been found that a transmit power of +30 dBmV allows for up to 60 dB of path loss through 250 feet of coaxial cabling utilizing multiple splitters, all without significantly interfering with existing services.

With such an arrangement, all data can be received and transmitted through an IEEE 802.3u compliant Ethernet port, and further can be transmitted transparently across network 51, emerging from point-to-point unchanged. Because packets are not altered, it is interoperable with all typical network services, such as Internet Protocol Television (IPTV), Voice over Internet Protocol (VoIP), web browsing and File Transfer Protocol (FTP), as well as other less common protocols, such as Apple Talk, IPX, LLC and NetBIOS.

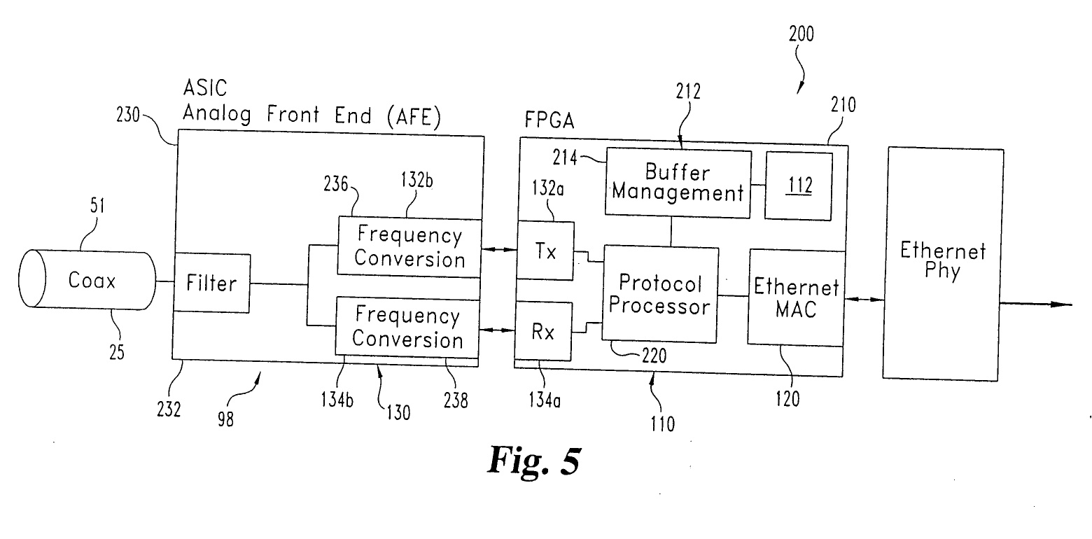

Referring to FIG. 5, a further example of a circuitry implementation of networking device 98 is illustrated as device circuitry 200 that is particularly amenable to Binary Phase Shift Key (BPSK) modulation; where like reference numerals refer to like features previously described. Device circuitry 200 includes digital processing circuitry 110 and transceiver 130. Digital processing circuitry 110 is implemented with Field Programmable Gate Array (FPGA) device 210, and transceiver 130 is implemented with Application Specific Integrated Circuit (ASIC) device 230 in this arrangement. Transceiver 130 is defined by analog circuitry 232 of device 230, and correspondingly provides an Analog Front End (AFE).

FPGA device 210 includes Ethernet controller 120, TXR digital portion 132a, and RXR digital portion 134a. Device 210 includes memory subsystem 212 coupled to protocol processor 220. Subsystem 212 includes memory 112 and buffer management unit 214. Protocol processor 220 controls and directs communication between TXR and RXR portions 132a and 134a, memory subsystem 212, and Ethernet controller 120; such that device 98 implements the operational aspects otherwise described herein. Ethernet controller 120 interfaces with the Ethernet PHY Layer as symbolically shown in FIG. 5 and previously described.

Circuitry 232 of ASIC 230 includes TXR analog portion 132b and RXR analog portion 134b. Portion 132b includes TXR frequency converter 236 to up-convert network communication signal frequency for transmission on network 51 modulated with a specified carrier frequency. Portion 134b includes RXR frequency converter 238 to down-convert frequency of a modulated communication signal input. Circuitry 232 further includes Input/Output (I/P) filter 234.

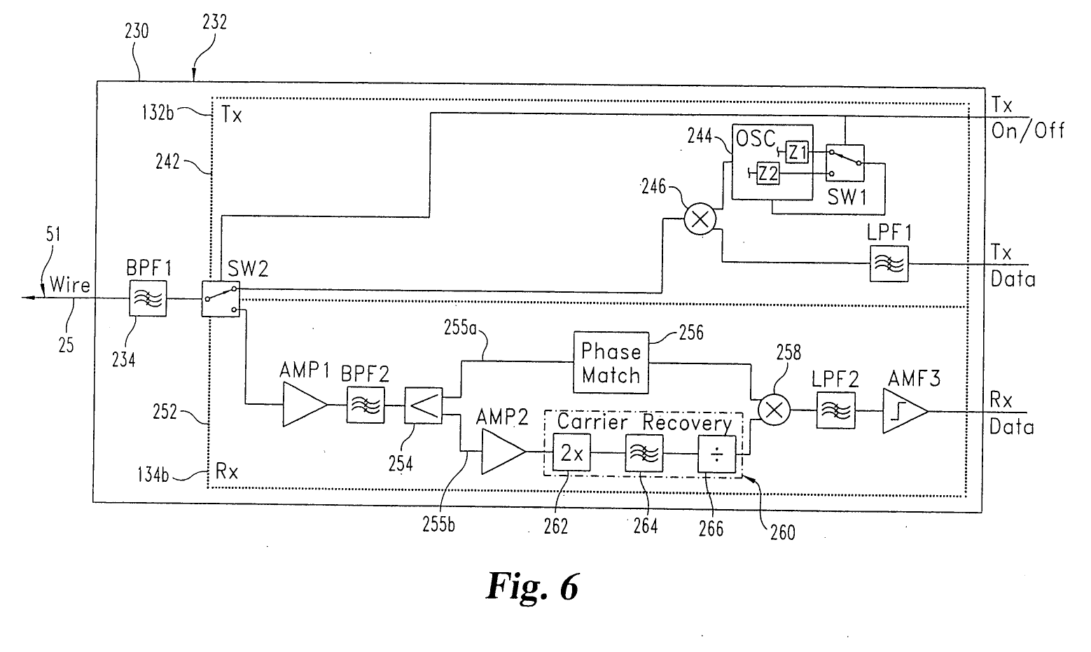

Referring additionally to FIG. 6, additional aspects of circuitry 232 are illustrated. Network 51 connects to circuitry 232 with bandpass filter 234 (alternatively designated BPF1) coupled to switch circuitry SW2. In one embodiment, BPF1 defines a bandwidth corresponding to the communication channel width defined by the communication protocol for network 51. Switching circuitry SW2 is responsive to a binary TX ON/OFF signal input from circuitry 110 of device 210. Switching circuitry SW2 connects analog TXR portion 132b to cabling 25 of network 51 when TX ON/OFF is true to facilitate a “transmit” mode of operation, and otherwise connects analog RXR portion 134b to cabling 25 of network 51. Correspondingly, the TX ON/OFF signal is used to toggle between “transmit” and “receive” modes of operation. Transmitter circuitry 242 of portion 132b includes communication signal carrier frequency oscillator 244, modulation mixer 246, low pass filter LPF1, and switch circuitry SW1. In one embodiment, LPF1 is a second order low pass data filter.

The TX ON/OFF signal input also activates and deactivates oscillation of oscillator 244. In one form, oscillator (OSC) 244 is deactivated by stabilizing it to cease oscillation as opposed to its oscillatory behavior when operating in a nominal destabilized oscillating mode. For this form, stabilization can be imposed by changing electrical impedance used in the oscillator circuitry, such as impedance associate with one or more oscillator port terminations. In FIG. 6, different impedances of this type are symbolically represented by Z1 and Z2. Accordingly, oscillator 244 is toggled between active and inactive states (unstable and stable, respectively) in correspondence with its operation as a transmitter on network 51.

When in an active mode, TX (transmitted) data from circuitry 110 that passes through LPF1 is input to mixer 246 and is up-converted to provide a modulated communication output signal from digital TXR portion 132a. For the nonlimiting example having a 600 MHz-wide communication channel, corresponding up-conversion would be to accommodate the 600 MHz or 1.35 GHz center frequency. For this arrangement, portion 132a supplies a data frequency of 125 MHz to portion 132b that is then up-converted.

When the TX ON/OFF signal is false, switching circuitry SW2 connects cabling 25 of network 51 to RXR portion 134b to operate in the receive mode. Receiver circuitry 252 of portion 134b includes: amplifier AMP1 that operates as a gain block running in saturation, band pass filter BPF2, active signal splitter 254 that divides the received input signal for transmission along both branches 255a and 255b, demodulation mixer 258, low pass filter LPF2, and amplifier AMP3. Branch 255a includes phase matching circuit 256. Branch 255b includes amplifier AMP2, and carrier recovery circuitry 260. Both branches 255a and 255b provide inputs to demodulation mixer 258. The output of mixer 258 is provided to low pass filter LPF2 and amplifier AMP3. LPF2 is arranged with a cutoff frequency to isolate data resulting from demodulation, and amplifier AMP3 is a limiting type operable as a data slicer. The output of AMP3 is provided to digital RXR portion 134a of circuitry 110 for further processing as otherwise described herein. The operation of circuitry 252 is further described in connection with carrier signal recovery and demodulation for BPSK-modulated signals received from network 51. Circuitry 260 includes passive frequency doubler 262 (a form of frequency multiplier), analog filter 264, and frequency divider 266. AMP2 operates in conjunction with circuitry of doubler 262 (symbolized “2x” in FIG. 6) to output the modulated input communication signal at twice the frequency received. The doubled frequency output corresponds to increasing the frequency by a desired multiple, in this case a factor of two. One implementation includes a Gilbert Cell mixer form of doubler that results in a predominant second harmonic output with some residual fundamental and other harmonics. After doubling the modulated input signal frequency, filter 264 removes remaining data content from the multiplied frequency signal output by doubler 262. Filter 264 outputs the filtered signal to divider 266 (symbolized by “÷” in FIG. 6). Divider 266 divides the frequency of the input signal by two, the same factor used with doubler 262. This resulting output of divider 266 is input to mixer 258 as a faithful representation of the carrier frequency without data modulation. For one Gilbert Cell/BPSK modulation implementation, filter 264 is of a bandpass type structured to further reduce fundamental and harmonic signal constituents other than the second harmonic, and provide the resulting output to a Delay (D) Flip Flop form of divider 266.

By using circuitry 260, carrier signal recovery can be performed with less latency compared to other approaches. Phase matching circuit 256 is structured to match the phase between branches 255a and 255b to within an acceptable tolerance using the recovered carrier signal from circuitry 260. In one nonlimiting example, the phase match was less than or equal to 25 degrees. Demodulation with circuitry 260 is particularly amenable to BPSK modulation techniques and the like.

Referring generally to FIGS. 1-3, 5, and 6; data received over network 51 by any networking device 98 is transmitted over a single signal channel at an appropriate time. Upon receiving data, networking device 98 decodes the communication (information signal) back into an Ethernet-compliant data form for transmission on Ethernet bus 37. To receive a data packet on Ethernet bus 37, the Ethernet MAC of controller 120 operates in a promiscuous mode in one embodiment, such that it receives all data packets, even if not intended for the particular networking device 98. In this promiscuous mode, controller 120 stores all received data packets into an internal memory (not shown). When controller 120 determines that data is to be transmitted with networking device 98, the data is read from this internal memory and sent to circuitry 120 for transmission. Circuitry 120 then prompts transmission of this data over network 51 at a selected time.

In one embodiment, modules 100 communicate over network 100 in accordance with a Carrier Sense Multiple Access/Collision Detection (CSMA/CD) protocol. This CSMA/CD protocol is arbitrated by one of the networking devices 98 previously also designated master device 100a. Master device 100a assumes use of the entire designated channel and allocates time slots for transmission by adapters 100. Because master device 100a controls the communication channel, it may transmit its own data or arbitrate/announce transmission priority for adapters 100. While all adapters 100 can include operating logic arranged to perform as a master device 100a in accordance with this protocol, it is desirable that only one be designated to do so. It has been found that it is desirable to designate the networking device 98 closest to the broadband network modem 38 as master device 100a.

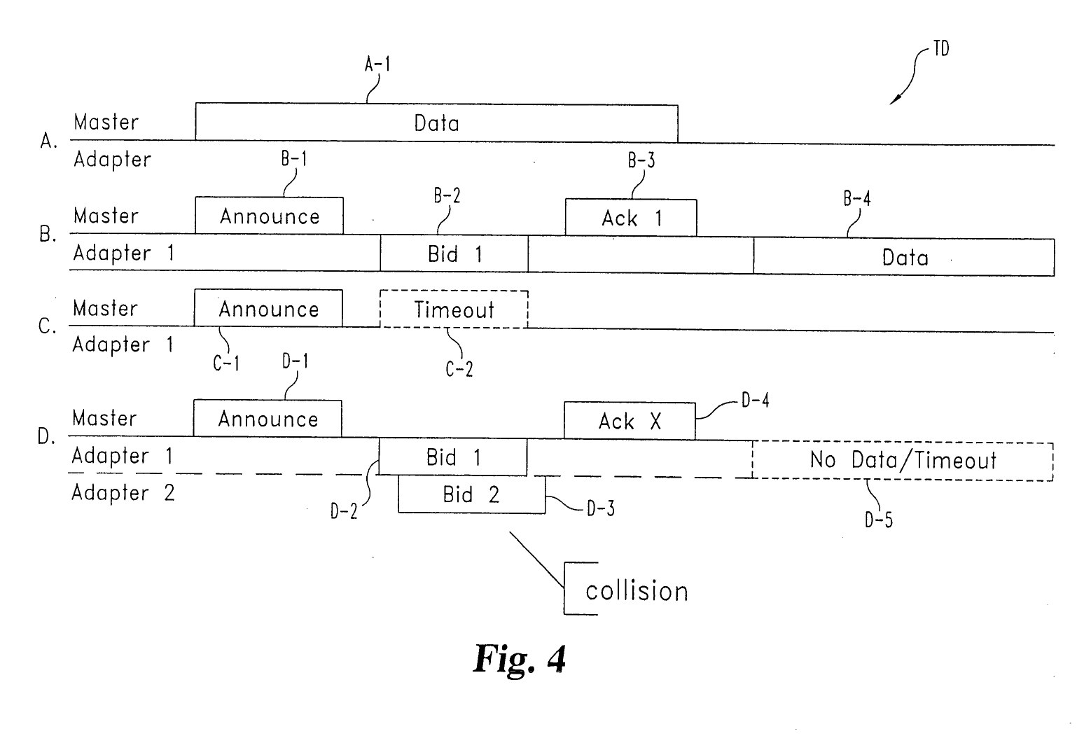

Referring additionally to FIG. 4, further details of one form of this protocol are provided by timing diagram TD, which illustrates four different communication sequences A, B, C, and D that can take place over network 51. This protocol allows multiple adapters 100 to divide up a single, half-duplex communication channel so that it can be shared for point-to-multipoint communication. Communication master device 100a controls communication between all networking devices 98. While the data does not pass through master device 100a, adapters 100 only transmit over the communication channel when permission is granted by master device 100a. In sequence A of FIG. 4, master device 100a gives itself permission to transmit over network 51 by sending data that will be received by all adapters 100 as represented by segment A-1. In sequence B of FIG. 4, master device 100a invites communication by one of adapters 100 by a sending a message announcing that all adapters 100 may now bid for the next designated communication time slot in segment B-1. One of adapters 100 (alternatively designated “Adapter 1”) responds to this invitation with a reply (“bid 1”) in segment B-2. This reply by Adapter 1 indicates acceptance of the timeslot by sending an adapter identifier to master device 100a that is unique relative to the other adapters 100. In response, master device 100a acknowledges that Adapter 1 may transmit in segment B-3 by sending Adapter 1 its corresponding identifier or other message that is unique relative to the other adapters 100. In reply, Adapter 1 transmits data over network 51 as represented by segment B-4.

Under this protocol, adapters 100 may not transmit except to bid in response to an invitation to transmit data from master device 100a and to subsequently transmit the data in response to a proper acknowledgement from master device 100a. If no adapters have any data to send, such that a “no bid” situation arises, master device 100a times out (segment C2) after sending an announcement (segment C-1), as illustrated in sequence C. In sequence D, two adapters 100 (more specifically designated “Adapter 1” and “Adapter 2”) attempt to bid for the same timeslot in response to announcement to bid by master device 100a, as represented by segment D-1. These competing bids, as represented by segments D-2 and D-3, correspond to a communication collision condition, with a result that is either unintelligible data, which is ignored by the master device 100a, an incorrect acknowledgement number in segment D-4, or both. Correspondingly, a time-out results for the current timeslot as represented by segment D-5. In response to a missing/inappropriate acknowledgement signal (segment D-4) from master unit 100a, the bidding adapters 100 causing the collision condition perform a “back-off” routine to randomly select a delay period before attempting to bid again in response to an announcement from master device 100a. In this manner, the chance that the same adapters 100 will consecutively cause repeat collision conditions is diminished. Typically, the random delay is based on psuedorandom number generation with certain constraints, although other approaches may alternatively or additionally be utilized.

Many different embodiments are envisioned. In one form, different protocols are used. Furthermore, the communication protocol could include utilization of a master module/adapter and/or providing a pre-established sequence order based on a unique identifier, such as a product serial number, a MAC number or the like. Alternatively or additionally, master device 100a may be dedicated only to communication arbitration such that it lacks an Ethernet interface connected to device(s) 30. In another embodiment, master device 100a lacks some adapter 100 capability (such as logic for the adapter side of the communication protocol) and/or has additional capabilities. Alternatively or additionally, one or more adapters 100 may differ from one or more other adapters 100.

A further embodiment of the present invention is a method, comprising: designating a building in which previously installed coaxial cabling was utilized to provide television programming; installing a computer network in the building by coupling a number of communication devices together with the cabling, the networking devices including a master module and a plurality of adapters that communicate over the first computer network in accordance with a first protocol, the adapters each including a port to interface to at least one device to communicate in accordance with a second protocol; interfacing each of the adapters to a different computer network with a second protocol, the adapters each converting at least some information between the first protocol and the second protocol; and with the master module, controlling communications among the adapters over the computer network in accordance with the first protocol by: (a) sending a first signal over the computer network to invite communication by the adapters over the computer network; (b) if only one of the adapters responds to the first signal, transmitting a second signal over the computer network to prompt communication by the one of the adapters; and (c) if two or more of the adapters respond to the first signal, transmitting a third signal over the computer network to indicate a communication collision condition exists. In one form, this method further includes: in response to the second signal, broadcasting information from the one of the adapters to other of the adapters over the computer network; and/or in response to the third signal, the two or more of the adapters each delaying further transmission as a function of a randomly determined time period. Other embodiments include systems configured to operate in accordance with these methods and variations thereof. Still further embodiments include apparatus, adapters, modules, or other devices including operating logic executable to perform at least a portion of any of these methods and variations thereof.

Yet another embodiment is directed to a system including a computer network provided by coupling a number of network communication devices together with coaxial cabling. This cabling can be of the type previously structured to transmit television programming. The devices include a master module and a plurality of adapters that communicate over the computer network in accordance with a first communication protocol. The system further includes means for interfacing each of the adapters to one or more devices with a second communication protocol, with the adapters each including means for converting at least some information between the first protocol and the second protocol; and means for controlling communications among the adapters with the master module in accordance with the first protocol by sending a first signal over the computer network to invite communication by the adapters over the computer network, transmitting a second signal over the computer network to prompt communication by one of the adapters if the one of the adapters is the only to respond, and transmitting a third signal over the computer network corresponding to a communication collision condition if two or more of the adapters respond to the first signal. The adapters each include means for selectively responding to the first signal and broadcasting information from the one of the adapters to other of the adapters in response to the first signal, and means for delaying further transmission by the two or more of the adapters as a function of a randomly determined time period in response to the third signal.

Another embodiment of the present application is a method, comprising: designating a building in which previously installed coaxial cabling was utilized to provide television programming; installing a computer network in the building by coupling a number of networking devices together with the cabling, the networking devices each including a transmitter carrier signal oscillator to transmit information on the computer network in accordance with the first protocol; communicating between the networking devices over the cabling in accordance with a first protocol; interfacing each of the networking devices to a different computer network with a second protocol; and when not transmitting, selectively changing impedance of circuitry to halt oscillating signal output of the oscillator for each of the devices when in a receive mode of operation. Other embodiments include systems configured to operate in accordance with these methods and variations thereof. Still further embodiments include apparatus, adapters, modules, or other devices including operating logic executable to perform at least a portion of any of these methods and variations thereof.

Another embodiment of the present application is a method, comprising: designating a building in which previously installed coaxial cabling was utilized to provide television programming; installing a computer network in the building by coupling a number of networking devices together with the cabling, the networking devices each including a signal receiver to receive information from the computer network in accordance with the first protocol; communicating between the networking devices over the cabling in accordance with a first protocol; interfacing each of the networking devices to a different computer network with a second protocol; and for each of the networking devices, operating the receiver by multiplying frequency of a received signal by a selected factor to provide a multiplied signal, filtering the multiplied signal to remove data encoded thereon, dividing the multiplied signal by the factor after the data is removed by the filtering to provide a recovered carrier signal, and demodulating the received signal with the recovered carrier signal. In one form, the input signal is BPSK modulated and/or the factor is two such that multiplying doubles frequency and dividing halves frequency. Other embodiments include systems configured to operate in accordance with these methods and variations thereof. Still further embodiments include apparatus, adapters, modules, or other devices including operating logic executable to perform at least a portion of any of these methods and variations thereof.

Still a further embodiment includes a method of carrier signal recovery that comprises: multiplying frequency of an modulated input signal by a selected factor to provide a multiplied signal, filtering the multiplied signal to remove data encoded thereon, dividing the multiplied signal by the factor after the data is removed by the filtering to provide a recovered carrier signal, and demodulating the modulated input signal with the recovered carrier signal. In one form, the input signal is BPSK modulated and/or the factor is two such that multiplying doubles frequency and dividing halves frequency. Other embodiments include systems configured to operate in accordance with these methods and variations thereof. Still further embodiments include apparatus, adapters, modules, or other devices including operating logic executable to perform at least a portion of any of these methods and variations thereof.

Another embodiment of the present application includes a number of networking devices coupled together by coaxial cabling to define a computer network, the networking devices each including: a transmitter carrier signal oscillator to transmit information on the computer network in accordance with a first protocol and means for selectively changing impedance in the oscillator of each of the devices to halt oscillating signal output when not transmitting with the oscillator; means for interfacing with a different computer network and communicating in accordance with a second protocol over the different computer network, and a receiver that includes means for multiplying frequency of a modulated input signal by a factor to provide a multiplied signal, means for filtering the multiplied signal to remove data encoded thereon, means for dividing the multiplied signal by the factor after the data is removed by the filtering to provide a recovered carrier signal, and means for demodulating the modulated input signal with the recovered carrier signal.

In a further embodiment, a system includes a number of networking devices coupled together with coaxial cabling to provide a computer network that each include receiver circuitry to receive a modulated input signal in accordance with a first communication protocol and an interface to communicate over a different computer network with a second communication protocol different than the first communication protocol, the receiver circuitry includes a multiplier to multiply the input signal by a factor to provide a multiplied signal, a filter to filter the multiplied signal to remove data encoded thereon, a divider to divide the multiplied signal by the factor after the data is removed by the filter to provide a recovered carrier signal, and a demodulation circuit to demodulate the modulated input signal with the recovered carrier signal.

In yet a further embodiment, a computer network is provided by coupling a number of network communication devices together with coaxial cabling. These devices are each structured to communicate with modulated signals over the computer network in accordance with a first protocol and to communicate over one or more other computer networks in accordance with a second protocol. The devices each include carrier recovery circuitry to generate carrier signals corresponding to the modulated signals. This circuitry includes: a frequency multiplier structured to multiply frequency of each of the modulated signals by a multiplying factor to provide respective multiplied signals, a filter to attenuate content of each of the multiplied signals to provide respective filtered signals (the content of the filtered signals corresponding to data encoded on the modulated signals), a divider to divide each of the filtered signals by the multiplying factor to recover the respective carrier signals, and a mixer structured to demodulate the modulated signals with the respective carrier signals to provide the data encoded thereon.

Still a further embodiment includes: installing a computer network in the building by coupling a number of networking devices together with coaxial cabling that each have transmitter circuitry and receiver circuitry to communicate information over the computer network in accordance with a first communication protocol; interfacing each of the networking devices between the computer network and a respective one or more other devices to communicate therewith in accordance with a second protocol different than the first protocol; and for each of the networking devices, operating the receiver circuitry, which includes: (a) multiplying frequency of a modulated input signal by a factor to provide a multiplied signal, (b) filtering the multiplied signal to attenuate content of the multiplied signal to provide a filtered signal, (the content corresponding to encoded data), (c) dividing the filtered signal by the factor to provide a recovered carrier signal, and (d) demodulating the modulated input signal with the recovered carrier signal.

For another embodiment, an apparatus comprises: a computer network provided by coupling a number of networking devices together with coaxial cabling that each have transmitter circuitry and receiver circuitry to communicate information over the computer network in accordance with a first communication protocol; means for interfacing each of the networking devices between the computer network and a respective one or more other devices to communicate therewith in accordance with a second protocol different than the first protocol; and for each of the networking devices, means for operating the receiver circuitry, which includes: (a) means for multiplying frequency of a modulated input signal by a factor to provide a multiplied signal, (b) means for filtering the multiplied signal to attenuate content of the multiplied signal to provide a filtered signal (the content corresponding to encoded data), (c) means for dividing the filtered signal by the factor to provide a recovered carrier signal, and (d) means for demodulating the modulated input signal with the recovered carrier signal.

Alternatively, a further embodiment comprises: designating a building in which previously installed coaxial cabling was utilized to provide television programming; installing a computer network in the building by coupling a number of networking devices together with the coaxial cabling to communicate among one another in accordance with a first protocol that are each operable in a transmit mode and a receive mode and each include oscillator circuitry with an adjustable impedance; interfacing each of the networking devices between the computer network and a respective one or more other devices to communicate therewith in accordance with a second protocol different than the first protocol; during operation in the transmit mode, the networking devices each operating the oscillator circuitry with a first value of the adjustable impedance to promote oscillatory behavior thereof and generate an oscillating output signal to perform modulation therewith; and during operation in the receive mode, the networking devices each operating the oscillator circuitry with a second value of the adjustable impedance to stabilize the oscillator circuitry and suspend the oscillatory behavior thereof, and correspondingly generate an output signal with reduced oscillating content.

In a different embodiment, a computer network is provided by coupling a number of networking devices together with coaxial cabling that each communicate over the computer network in a transmit mode and a receive mode in accordance with a first protocol. These networking devices each communicate over a different computer network in accordance with a second protocol. Each respective one of the devices includes: receiver circuitry connected to the cabling; transmitter circuitry connected to the cabling, the transmitter circuitry including a mixer and an oscillator with an adjustable impedance; and digital processing logic structured to selectively input a digital data signal to the mixer for modulation with a carrier signal when the respective one of the networking devices operates in the transmit mode. The logic generates a control signal to change between operation of the oscillator with a first value of the adjustable impedance and a second value of the adjustable impedance. The first value destabilizes the operation of the oscillator to promote oscillatory behavior and correspondingly generate the carrier signal during the transmit mode. The second value stabilizes the operation of the oscillator to suspend the oscillatory behavior thereof, and correspondingly generate an output with reduced oscillating content during the receive mode.

Yet a further different embodiment includes: a networking device structured to form a computer network with one or more other devices through coaxial cabling in accordance with a first communication protocol and to communicate over a different computer network in accordance with a second communication protocol. This device operates in a transmit mode and a receive mode over the computer network, and includes transmitter circuitry including an oscillator with an adjustable impedance and a modulation mixer structured to transmit a modulated output signal over the computer network to the one or more other devices when operating in the transmit mode. The oscillator is responsive to a control signal to change the adjustable impedance to reduce oscillating output of the oscillator over the computer network during operation in the receive mode. The networking device further includes receiver circuitry operable to demodulate a modulated input signal received from the one or more other devices over the computer network when operating in the receive mode. This receiver circuitry comprises: a frequency multiplier structured to multiply frequency of the modulated input signal by a multiplying factor to provide a corresponding multiplied signal, a filter to attenuate content of the multiplied signal to provide a corresponding filtered signal, a divider to divide the filtered signal by the multiplying factor to recover a carrier signal, and a demodulation mixer structured to demodulate the modulated input signals with the carrier signal to provide data encoded thereon.

Still another embodiment is directed to a system, comprising: multiple networking devices structured to be coupled together by coaxial cabling to provide a computer network that includes a master module and several adapters to communicate in accordance with a first protocol over the computer network, means for controlling communication with the master module by sending a first signal to the adapters to invite communication by one of the adapters over the computer network, the controlling means including means for transmitting a second signal to prompt communication if only the one of the adapters responds to the first signal and means for transmitting a third signal to the adapters if two or more of the adapters respond to the first signal; and wherein the adapters each include: (a) means for interfacing each of the adapters to a different network to communicate in accordance with a second protocol and converting at least some information between the first protocol and the second protocol; (b) means for broadcasting data to other of the adapters in response to the second signal; (c) means for randomly delaying transmission in response to the third signal; (d) means for demodulating a modulated input signal received over the computer network when operating in a receive mode that includes: means for multiplying frequency of the modulated input signal to provide a multiplied signal, means for filtering the multiplied signal to attenuate undesired content to provide a filtered signal, and means for dividing the filtered signal to recover a carrier signal for demodulation of the modulated input signal; and (e) means for transmitting a modulated output signal over the computer network when operating in a transmit mode that includes means for reducing undesired output over the computer network, the reducing means including an oscillator with an adjustable impedance and means for changing the adjustable impedance to suspend oscillatory operation of the oscillator circuitry when operating in the receive mode.

All publications, patents, and patent applications cited in this specification are herein incorporated by reference as if each individual publication, patent, or patent application were specifically and individually indicated to be incorporated by reference and set forth in its entirety herein. While the invention has been illustrated and described in detail in the drawings and foregoing description, the same is to be considered as illustrative and not restrictive in character, it being understood that only selected embodiments have been shown and described and that all changes, equivalents, and modifications that come within the spirit of the inventions defined herein and/or by following are desired to be protected.

1. A method, comprising:
designating a building in which previously installed coaxial cabling was utilized to provide television programming;
installing a computer network in the building by coupling a number of communication devices together with the cabling, the devices including a master module and a plurality of adapters that communicate over the first computer network in accordance with a first protocol, the adapters each including a port to interface to at least one device to communicate in accordance with a second protocol;
with the master module, controlling communications among the adapters over the computer network in accordance with the first protocol by: sending a first signal over the computer network to invite communication by the adapters; if only one of the adapters responds to the first signal, transmitting a second signal over the computer network to prompt communication by the one of the adapters; and if two or more of the adapters respond to the first signal, transmitting a third signal over the computer network to indicate a communication collision condition;
in response to the second signal, broadcasting information from the one of the adapters to other of the adapters over the computer network; and
in response to the third signal, the two or more of the adapters each delaying further transmission as a function of a randomly determined time period.

2. (canceled)

3. (canceled)

4. The method of claim 1, wherein the broadcasting includes directly transmitting the information from the one of the adapters to each of the other of the adapters through the cabling.

5. The method of claim 1, wherein the broadcasting includes transmitting the information as signals extending over a designated frequency range and which includes detecting the signals over the designated frequency range with the other of the adapters to receive the information.

6. The method of claim 1, wherein the randomly determined time period is determined by psuedorandom number generation for each of the two or more adapters.

7. The method of claim 1, which includes arbitrating the communication in accordance with communication arbitration logic carried with the master module.

8. (canceled)

9. The method of claim 1, wherein the building is a residential dwelling and the interfacing includes:
coupling a first one of the adapters to a first device in a first room of the dwelling;
coupling a second one of the adapters to a second device in a second room of the dwelling; and
communicating between the first device and the second device through the first one of the adapters and the second one of the adapters and the coaxial cabling.

10. The method of claim 1, wherein the building is a residential dwelling and further comprising:
transmitting the television programming through the cabling after said installing; and
routing the television programming to a number of televisions in the residential dwelling.

11. The method of claim 1, wherein the broadcasting is performed over a frequency band with a center frequency of about 80 MHz and a bandwidth of about 40 MHz.

12. An apparatus, comprising: a module with logic executable by processing circuitry to perform communication arbitration among a number of adapters of a computer network when coupled together by coaxial cabling suitable to transmit television programming, the adapters each including an Ethernet interface to communicate with one or more devices coupled thereto, the logic being operable to: (a) send a first signal over the computer network to invite communication by the adapters over the computer network; (b) if only one of the adapters responds to the first signal, transmit a second signal over the computer network to prompt communication by the one of the adapters; and (c) if two or more of the adapters respond to the first signal, transmit a third signal over the computer network corresponding to a communication collision condition.

13. The apparatus of claim 12, wherein the logic is in the form of programming instructions encoded in memory.

14. The apparatus of claim 12, wherein the logic is in the form of programming instructions carried by at least a portion of a wide area computer network.

15. The apparatus of claim 12, wherein the logic is further operable to determine a time-out condition.

16. The apparatus of claim 12, wherein the logic is further operable to send data received from the computer network to an Ethernet port and to send other data over the computer network received from the Ethernet port.

17. An apparatus, comprising: a computer network provided by coupling a number of network communication devices together with coaxial cabling, the devices each being structured to communicate with modulated signals over the computer network in accordance with a first protocol and the devices each being operable to communicate over one or more other computer networks in accordance with a second protocol, the devices each including carrier recovery circuitry to generate carrier signals corresponding to the modulated signals, the carrier recovery circuitry including:
a frequency multiplier structured to multiply frequency of each of the modulated signals by a multiplying factor to provide respective multiplied signals,
a filter to attenuate content of each of the multiplied signals to provide respective filtered signals, the content of the filtered signals corresponding to data encoded on the modulated signals,
a divider to divide each of the filtered signals by the multiplying factor to recover the respective carrier signals, and
a mixer structured to demodulate the modulated signals with the respective carrier signals to provide the data encoded thereon.

18. The apparatus of claim 17, wherein the devices each include transmitter circuitry structured to provide one or more of the modulated signals with BPSK modulation, the factor is two, and the divider is in the form of a D-flip flop.

19. The apparatus of claim 18, wherein the transmitter circuitry includes a mixer and an oscillator with an adjustable impedance, a first value of the adjustable impedance destabilizing the oscillator to promote oscillatory behavior and generate an oscillating output signal that is input to the mixer to perform modulation, and a second value of the adjustable impedance stabilizing the oscillator to suspend the oscillatory behavior and correspondingly generate an output signal with reduced oscillating content.

20. The apparatus of claim 17, further comprising digital processing circuitry to receive the data after demodulation and to provide a control signal, the transmitter circuitry being responsive to the control signal to change between the first value of the adjustable impedance and the second value of the adjustable impedance.

21. The apparatus of claim 17, wherein the devices include a master module and a plurality of adapters, the master module includes processing circuitry operable to generate: a first signal to transmit over the computer network to invite communication by the adapters; a second signal to transmit over the computer network to prompt communication by one of the adapters if the one of the adapters is the only one that responded to the first signal, a third signal to transmit over the computer network to indicate a communication collision condition exists if two or more of the adapters responded to the first signal; and
further wherein the one of the adapters responds to the second signal by broadcasting information to other of the adapters over the computer network and the two or more of the adapters each respond to the third signal by delaying further transmission.

22. A system, comprising:
a dwelling;
coaxial cabling previously installed in the dwelling and structured to transmit television programming;
a number of communication devices coupled together with the cabling to provide a computer network in the dwelling, the devices including a master module and a plurality of adapters that communicate over the computer network in accordance with a first communication protocol, the adapters each including an interface with a second communication protocol different than the first communication protocol;
a number of devices each coupled to the interface of a corresponding one of the adapters;
the master module including processing circuitry operable to generate: a first signal to transmit over the computer network to invite communication by the adapters; a second signal to transmit over the computer network to prompt communication by one of the adapters if the one of the adapters is the only one that responded to the first signal, a third signal to transmit over the computer network to indicate a communication collision condition exists if two or more of the adapters responded to the first signal; and
wherein the one of the adapters responds to the second signal by broadcasting information to other of the adapters over the computer network and the two or more of the adapters each respond to the third signal by delaying further transmission as a function of a randomly determined time period.

23. The system of claim 22, wherein the adapters each include an ASIC that at least partially defines operating logic to communicate in accordance with the first protocol.

24. (canceled)

25. The system of claim 22, wherein the devices include at least one Ethernet switch and at least one set-top box.

26. A method, comprising:
installing a computer network by coupling a number of networking devices together with coaxial cabling, the networking devices each including transmitter circuitry and receiver circuitry to communicate information over the computer network in accordance with a first communication protocol;
interfacing each of the networking devices between the computer network and a respective one or more other devices to communicate therewith in accordance with a second protocol different than the first protocol; and
for each of the networking devices, operating the receiver circuitry, which includes: (a) multiplying frequency of a modulated input signal by a factor to provide a multiplied signal, (b) filtering the multiplied signal to attenuate selected spectral content of the multiplied signal to provide a filtered signal, the selected spectral content corresponding to encoded data, (c) dividing the filtered signal by the factor to provide a recovered carrier signal, and (d) demodulating the modulated input signal with the recovered carrier signal.

27. The method of claim 26, which includes generating the modulated input signal with BPSK modulation, the factor for the multiplying and the dividing being two.

28. The method of claim 26, wherein the demodulating includes:
providing the modulated input signal to a phase matching circuit;
providing an output of the phase matching circuit to an input of a demodulation mixer;
providing the recovered carrier signal to the demodulation mixer; and
providing demodulated data from the demodulation mixer to digital processing circuitry.

29. The method of claim 26, which includes designating a building in which the coaxial cabling was previously installed and utilized to provide television programming before the installing, and wherein the first protocol is of a point-to-multipoint type, the second protocol is of an Ethernet type, and the interfacing includes:
coupling a first one of the networking devices to a first device belonging to the respective one or more other devices in a first room of the building;
coupling a second one of the networking devices to a second device belonging to the respective one or more other devices in a second room of the building; and
communicating between the first device and the second device through the first one of the networking devices, the second one of the networking devices, and the coaxial cabling.

30. The method of claim 26, wherein the building is a residential dwelling and further comprising:
transmitting the television programming through the cabling after said installing; and
routing the television programming to a number of televisions in the residential dwelling.

31. The method of claim 26, wherein the devices include a master module and a plurality of adapters, and further comprising:
with the master module, controlling communications among the adapters over the computer network in accordance with the first protocol by: sending a first signal over the computer network to invite communication by the adapters over the computer network; if only one of the adapters responds to the first signal, transmitting a second signal over the computer network to prompt communication by the one of the adapters; and if two or more of the adapters respond to the first signal, transmitting a third signal over the computer network to indicate a communication collision condition exists;
in response to the second signal, broadcasting information from the one of the adapters to other of the adapters over the computer network; and
in response to the third signal, the two or more of the adapters each delaying further transmission as a function of a randomly determined time period.

32. The method of claim 26, wherein the transmitter circuitry includes a mixer and an oscillator with an adjustable impedance, and further comprising for each of the networking devices:
during the transmit mode, operating the oscillator with a first value of the adjustable impedance to promote oscillatory behavior thereof and generate an oscillating output signal that is input to the mixer to perform modulation, and
during the receive mode, operating the oscillator with a second value of the adjustable impedance to stabilize the oscillator and suspend the oscillatory behavior, and correspondingly generate an output signal with reduced oscillation.

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)
